(19) United States
(12) Patent Application Publication
(10) Pub. No.: US 2025/0021698 A1
(43) Pub. Date: Jan. 16, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Shinichi Kobayashi, Kanagawa (JP)

(73) Assignee: FUJIFILM Business Innovation Corp., Tokyo (JP)

(21) Appl. No.: 18/589,801

(22) Filed: Feb. 28, 2024

(30) Foreign Application Priority Data
Jul. 12, 2023 (JP) 2023-114280

(51) Int. Cl. G06F 21/62; H04L 9/32

(52) U.S. Cl. CPC G06F 21/629; H04L 9/3213; G06F 2221/2141

(57) ABSTRACT

An information processing system includes one or more processors, and, in response to a request from an external device, acquires, from an authorization server, and provides, to the external device, an access token that enables access to a designated service. The one or more processors are configured to: acquire, from the authorization server, and provide, to the external device, a first access token in which a first expiration period is set, when the request designating a first service is received; and acquire, from the authorization server, and provide, to the external device, a second access token in which a second expiration period shorter than the first expiration period is set, when the request designating a second service is received.

### CROSS-REFERENCE TO RELATED APPLICATIONS

This application is based on and claims priority under 35 USC 119 from Japanese Patent Application No. 2023-114280 filed Jul. 12, 2023.

### BACKGROUND

### (i) Technical Field

The present disclosure relates to an information processing system and a non-transitory computer readable medium.

### (ii) Related Art

From viewpoints of achieving single sign on (SSO) and improving security, for example, authentication called advanced authentication utilizing OAuth approval (which may be hereinafter sometimes referred to as “OAuth authentication”), has been introduced.

Japanese Unexamined Patent Application Publication No. 2014-142732 describes that an application that uses an authorization token to access a service holds service information, collates the service information with service information included in a request to the application, and uses the authorization token only when it is determined that the services are correct to access the service, preventing leakage of the authorization token.

### SUMMARY

In advanced authentication such as OAuth authentication, an external device presents, to a service side, an access token acquired based on an authentication setting to an authorization server. Then, when the presented access token is within an expiration period, the external device is allowed to access the service.

By the way, there is such an aspect that a cloud-based information processing system, for example, holds an authentication setting, and, in response to a request from an external device, acquires an access token from an authorization server and provides the acquired access token to the external device. If an access token with a long expiration period is always provided to the external device regardless of services in the aspect, the expiration period may be excessive for a service, a utilization period of which is relatively short, and, if the access token is leaked, the access token may be utilized in an unauthorized manner, possibly resulting in a greater damage. On the other hand, if an access token with a short expiration period is always provided regardless of services, the expiration period may be insufficient for a service, a utilization period of which is relatively long, which may prevent the access token from being smoothly utilized.

Aspects of non-limiting embodiments of the present disclosure relate to an information processing system that acquires an access token from an authorization server in response to a request from an external device and provides the acquired access token to the external device, to make compatible both suppression of allowing an expiration period of the access token to be excessive in a certain service and suppression of allowing the expiration period to be insufficient in another service.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including one or more processors, and, in response to a request from an external device, acquiring, from an authorization server, and providing, to the external device, an access token that enables access to a designated service, wherein the one or more processors are configured to: acquire, from the authorization server, and provide, to the external device, a first access token in which a first expiration period is set, when the request designating a first service is received; and acquire, from the authorization server, and provide, to the external device, a second access token in which a second expiration period shorter than the first expiration period is set, when the request designating a second service is received.

### BRIEF DESCRIPTION OF THE DRAWINGS

Exemplary embodiments of the present disclosure will be described in detail based on the following figures, wherein:

FIG. 1 is a diagram illustrating an example of a configuration of a service utilization system;

FIG. 2 is a block diagram illustrating an example of a hardware configuration of a token providing server;

FIG. 3 is a diagram illustrating an example of a hardware configuration of an external device;

FIG. 4 is a block diagram illustrating an example of a functional configuration of the token providing server to which a first exemplary embodiment is applied;

FIG. 5 is a block diagram illustrating an example of a functional configuration of the external device;

FIG. 6 is a sequence diagram illustrating an example of operation of the service utilization system;

FIG. 7 is a flowchart illustrating an example of operation related to provision of an access token in the token providing server to which the first exemplary embodiment is applied;

FIG. 8 is a block diagram illustrating an example of a functional configuration of a token providing server to which a second exemplary embodiment is applied; and

FIG. 9 is a flowchart illustrating an example of operation related to provision of an access token in the token providing server to which the second exemplary embodiment is applied.

### DETAILED DESCRIPTION

A first exemplary embodiment and a second exemplary embodiment will now be described herein in detail, as exemplary embodiments of the present disclosure, with reference to the accompanying drawings. Furthermore, when the first exemplary embodiment and the second exemplary embodiment are not particularly distinguished from each other, such as when a configuration common to the first exemplary embodiment and the second exemplary embodiment is described, the first exemplary embodiment and the second exemplary embodiment may be hereinafter sometimes referred to as the “present exemplary embodiment”.

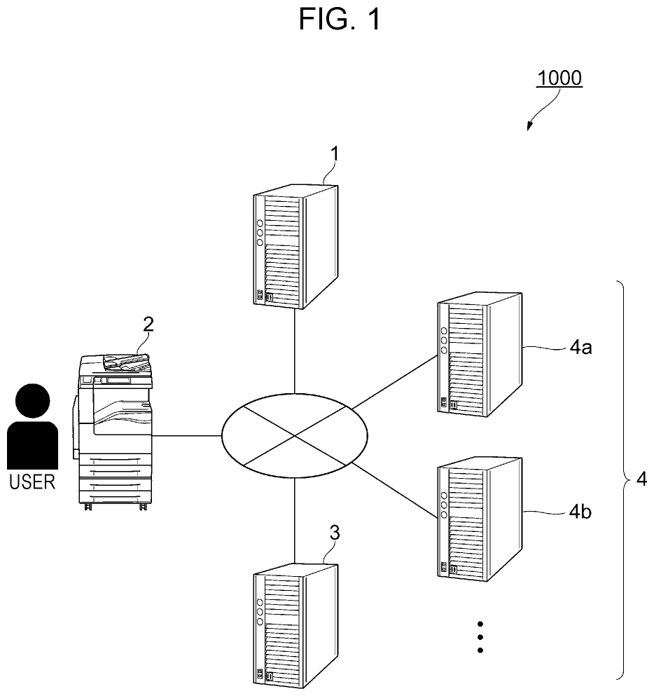

The first exemplary embodiment will now first be described herein with reference to FIGS. 1 to 7.

### First Exemplary Embodiment

### Service Utilization System 1000

FIG. 1 is a diagram illustrating an example of a configuration of a service utilization system 1000.

As illustrated in the figure, the service utilization system 1000 includes a token providing server 1, an external device 2, an authorization server 3, and service servers 4 (4a, 4b, etc.). Note that the respective devices are coupled to each other via a network. The network is not particularly limited, as long as it is possible to utilize the network for data communications between devices.

The service utilization system 1000 is a computer system that makes available, in the external device 2, services that the service servers 4 provide. More specifically, when utilization of (access to) the services that the service servers 4 provide is to be requested, the external device 2 in the service utilization system 1000 presents, to the service servers 4, an access token acquired based on an authentication setting to the authorization server 3. When the presented access token is valid, the service servers 4 provides the services to the external device 2.

An access token represents unique information that the authorization server 3 creates based on an authentication setting. An access token is given, for example, by several tens of digits of alphanumeric characters.

An access token is set with an expiration period, and, if an access token in which its expiration period has passed is presented, the service servers 4 do not permit utilization of the services.

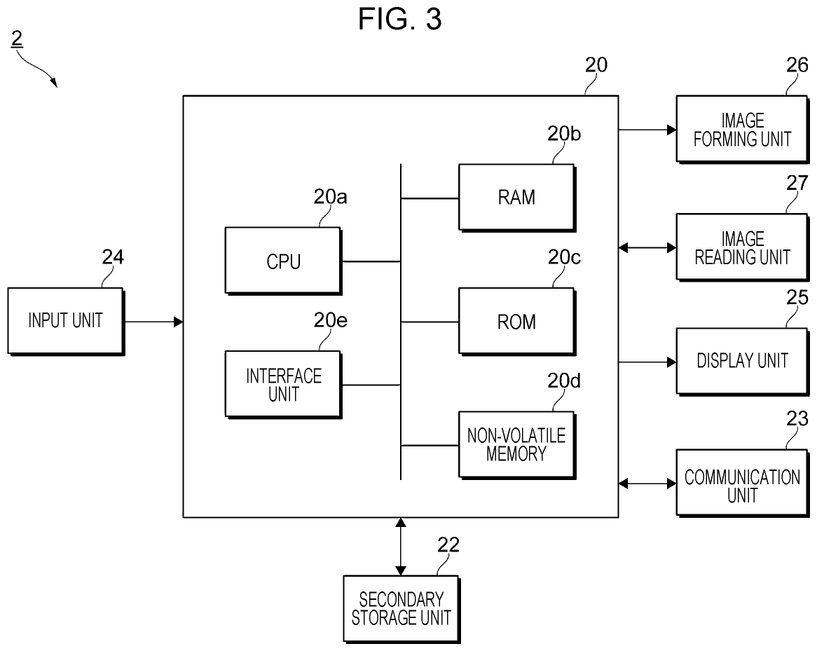

Note herein that it will now be considered an aspect in which the external device 2 directly acquires an access token from the authorization server 3 based on an authentication setting between the external device 2 and the authorization server 3. When a user utilizes a plurality of external devices 2 in the aspect, for example, it is necessary to perform an authentication setting to the authorization server 3 in each of the external devices 2, which is troublesome. Furthermore, when an identical or similar authentication setting is used to acquire an access token for a next time and onward, for example, it is necessary to cause each of the external devices 2 to hold information of the authentication setting to the authorization server 3, oppressing a storage capacity of each of the external devices (for example, a capacity of a secondary storage unit 22 described later with reference to FIG. 3).

Therefore, the present exemplary embodiment adopts an aspect in which an authentication setting is performed between the token providing server 1 and the authorization server 3, and the token providing server 1 acquires an access token from the authorization server 3 and provides the acquired access token to the external device 2.

The token providing server 1 is a server that acquires, from the authorization server 3, and provides, to the external device 2, an access token for a corresponding service, in response to a request from the external device 2.

As a device forming the token providing server 1, it is possible to utilize a computer device (an information processing device) that varies in type. Note that the token providing server 1 may include one computer or a plurality of computers. Furthermore, it may be configured as a so-called on-premise type server or a cloud type server.

The token providing server 1 is an example of an information processing system to which the first exemplary embodiment is applied.

The external device 2 is a device that the user utilizes. The external device 2 utilizes the services that the service servers 4 provide to execute various types of processing corresponding to an instruction of the user.

Note that the term “external device” indicates that it is a device external to the configuration of each of the service servers 4 (not included in the configuration of each of the service servers 4), and indicates that it is requested a certain type of authentication such as OAuth authentication when each of the services that the service servers 4 provide is utilized.

The present exemplary embodiment will now be described herein with reference to an example where the external device 2 is an image processing device capable of executing reading (scanning) of an image formed on a recording material and forming (printing) of an image on a recording material, for example. However, there are no limitations in the external device 2, as long as it includes a computer as a controller and utilizes the services that the service servers 4 provide, and a device that varies in type may be used.

The authorization server 3 is a server that issues an access token. The authorization server 3 issues an access token in response to a request from another device in an authorization flow, and passes the access token to the device representing a source of the request. The authorization flow refers to a procedure (a flow) for acquiring an access token, and includes a step of performing an authentication setting to the authorization server 3.

In addition, the authorization server 3 may issue and pass, to the device representing the source of the request, an update token in addition to an access token. An update token refers to a token used for requesting re-issuance of an access token when an expiration period of the access token has passed. Re-issuance of an access token in response to a request using an update token does not require an authorization flow. Note that an update token may be referred to as a refresh token.

The service servers 4 are servers that provide the services, respectively, in response to a request from another device. More specifically, when another device requests provision of the services and presents a valid access token, the service servers 4 provide the services to the device representing the source of the request.

Note herein that the service servers 4 provide the services that differ from each other. The services that differ from each other refer not only to services that differ from each other in type, such as a file storage service and a mail transmission service, which will be described later, but also to services that differ from each other in other elements. For example, such a case is included that a certain service server 4 and another service server 4 provide services that are identical to each other in type, but providers of the services differ from each other. Note that, although the example illustrated in FIG. 1 only illustrates two service servers 4a and 4b, there may be three or more service servers 4.

In the present exemplary embodiment, it is described, as an example, a case where it is possible that the service server 4a provides a service (which may be hereinafter sometimes referred to as a “file storage service”) for storing and archiving data received from the external device 2 in a designated storage location on the network. Furthermore, it is described, as an example, a case where it is possible that the service server 4b provides a service (which may be hereinafter sometimes referred to as a “mail transmission service”) for using a protocol called Simple Mail Transfer Protocol (SMTP) to transmit an electronic mail including data received from the external device 2 to a designated destination. The service server 4a may be hereinafter sometimes referred to as a file server 4a, and the service server 4b may be hereinafter sometimes referred to as an SMTP server 4b.

Note that the file storage service that the file server 4a provides is an example of a first service, and the mail transmission service that the SMTP server 4b provides is an example of a second service.

Then, in the present exemplary embodiment, it is possible that the external device 2, which is an image processing device, provides, to the user, a function of utilizing the file storage service that the file server 4a provides to store, in a designated storage location, image data created through scanning (which may be hereinafter sometimes referred to as a “scan storage function”). Furthermore, it is possible that the external device 2 provides, to the user, a function of utilizing the mail transmission service that the SMTP server 4b provides to send, to a designated destination, an electronic mail including image data created through scanning (which may be hereinafter sometimes referred to as a “scan mail function”).

Note that image data created through scanning is an example of data that the external device 2 holds and data that the service servers 4 acquire from the external device 2.

### Token Providing Server 1

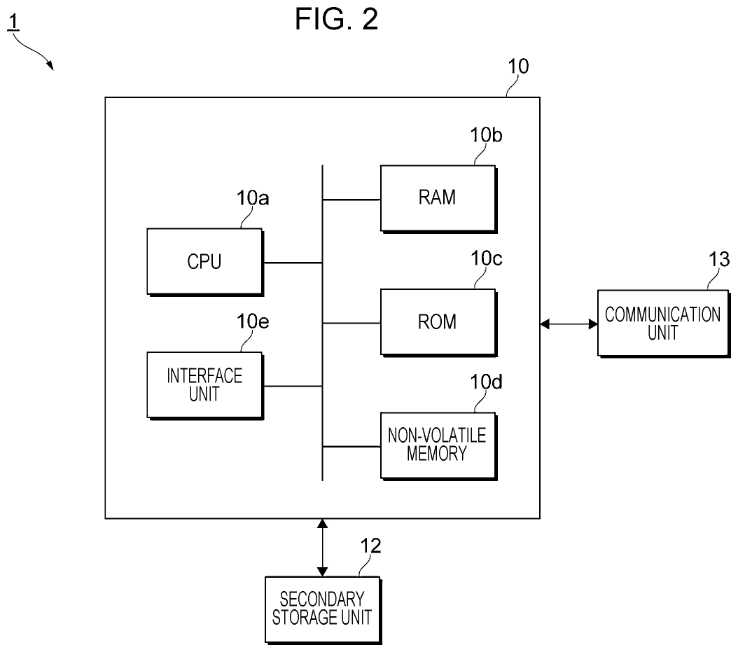

FIG. 2 is a block diagram illustrating an example of a hardware configuration of the token providing server 1.

As illustrated in the figure, the token providing server 1 includes a controller 10, a secondary storage unit 12, and a communication unit 13. Note that this configuration is a mere example, and the token providing server 1 may further include a display device capable of displaying various types of information on a screen and an input device capable of receiving an input of information by an administrator of a device, for example.

The controller 10 executes various types of processing in accordance with a program that has been read, and controls operation of the device itself. Furthermore, the controller 10 includes a central processing unit (CPU) 10a serving as an arithmetic calculator, a random access memory (RAM) 10b used as a working memory for the CPU 10a, and a read only memory (ROM) 10c in which programs that the CPU 10a executes and setting values prepared in advance, for example, are stored. Furthermore, a non-volatile memory 10d that is rewritable and is able to hold data even when power supply is stopped, and an interface unit 10e that controls each component such as the communication unit 13 coupled to the controller 10 are included. Note that the non-volatile memory 10d includes a static read only memory (SRAM) that a battery backs up or a flash memory, for example.

In the token providing server 1, the CPU 10a, which is an example of a processor, reads and executes the programs, achieving various types of functions described later.

Note herein that the various types of programs that the CPU 10a executes are provided in a state of being stored in a computer-readable recording medium such as a magnetic recording medium (a magnetic tape or a magnetic disk, for example), an optical recording medium (an optical disk, for example), a magneto-optical recording medium, or a semiconductor memory. Furthermore, the programs that the CPU 10a executes may be downloaded via a communication system such as the Internet. Note that the processor refers to a processor in a broad sense, and its examples include general-purpose processors (e.g., CPUs) and dedicated processors (e.g., GPUs: Graphics Processing Units, ASIC: Application Specific Integrated Circuits, FPGA: Field Programmable Gate Arrays, and programmable logic devices). Furthermore, operation of the processor may be achieved not only by one processor but also by a plurality of processors existing at physically distant positions in cooperation with each other. Furthermore, an order of steps in the operation of the processor is not limited to an order described in the present exemplary embodiment, and may be changed.

The secondary storage unit 12 records the programs that the CPU 10a executes, provides a database for storing various types of data that the token providing server 1 utilizes, such as authentication settings to the service servers 4 and access tokens/update tokens acquired from the authorization server 3, and memorizes the stored data, for example. The secondary storage unit 12 is achieved by, for example, a storage device such as a magnetic disk device or a solid state drive (SSD).

The communication unit 13 performs data communications with other devices via the network (see FIG. 1). As the communication unit 13, an interface conforming to a communication method that the network applies is used.

### Hardware Configuration of External Device 2

FIG. 3 is a diagram illustrating an example of a hardware configuration of the external device 2.

As illustrated in the figure, the external device 2 includes a controller 20, the secondary storage unit 22, a communication unit 23, an input unit 24, and a display unit 25. Furthermore, the external device 2 according to the present exemplary embodiment is an image processing device, and includes an image forming unit 26 and an image reading unit 27, which serve as components related to image processing.

Note that the controller 20 and the communication unit 23 in the external device 2 are identical or similar to the controller 10 and the communication unit 13 in the token providing server 1 described with reference to FIG. 2, respectively, and therefore, their descriptions are omitted in here.

The secondary storage unit 22 records the programs that a CPU 20a executes, and stores various types of data that the external device 2 utilizes, such as information related to a login to the token providing server 1, an access token acquired from the token providing server 1, image data that the image forming unit 26 uses for printing, and image data created from a result of reading in the image reading unit 27, for example. Similar to the secondary storage unit 12 in the token providing server 1, the secondary storage unit 22 is achieved by one of various types of storage devices.

The input unit 24 is a device including hardware buttons and switches that receive an input operation from the user, a touch sensor that outputs a control signal in accordance with an operation of touching with a finger, a code reader that reads code information such as a barcode or a quick response (QR) code (registered trademark), a card reader that reads an integrated circuit (IC) card, and a sensor that reads biological information of the user, for example.

The display unit 25 includes, for example, a liquid crystal display or an organic electro-luminescence (EL) display, and displays those including various types of information such as an image and text on a screen. Furthermore, a touch sensor serving as one part of the input unit 24 and the display unit 25 may be combined with each other to form a touch panel. In this case, software buttons for receiving an input operation from the user are displayed on the display unit 25, for example.

The image forming unit 26 includes, for example, a printer engine for a laser printer or an inkjet printer, for example, and forms and prints an image corresponding to image data onto a recording material such as a piece of paper in response to an instruction from the controller 20.

The image reading unit 27 includes an image scanner, for example, reads an image formed on a recording material (a document) such as a piece of paper in response to an instruction from the controller 20, and passes the image to the controller 20 as image data corresponding to a result of the reading.

### Hardware Configurations of Authorization Server 3 and Service Servers 4

The authorization server 3 and the service servers 4 each have, as an example, a hardware configuration similar to that of the token providing server 1 illustrated in FIG. 2. Furthermore, the authorization server 3 and the service servers 4 may each include a display device and an input device, for example, similar to the token providing server 1.

In addition, the service servers 4 include various types of components necessary for providing the services, respectively.

### Functional Configuration of Token Providing Server 1

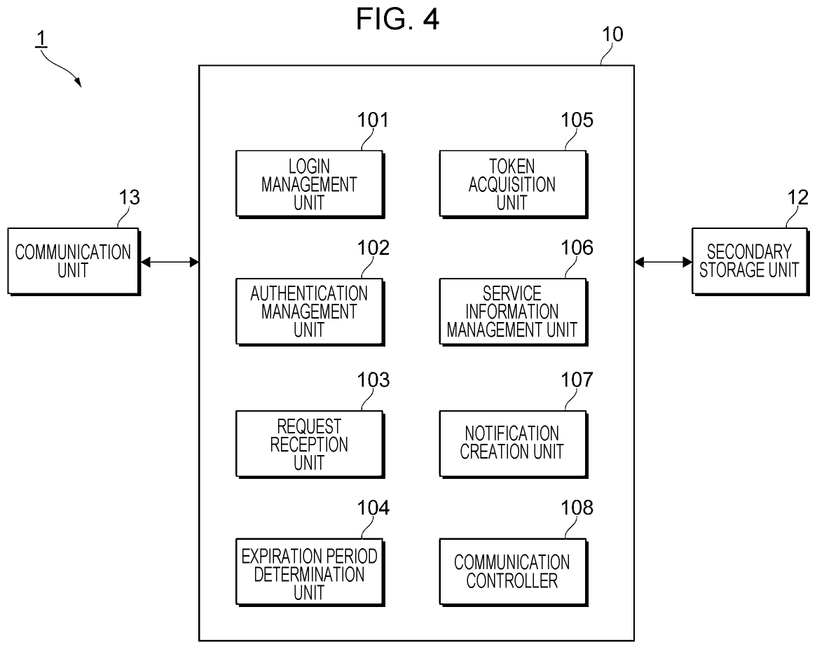

FIG. 4 is a block diagram illustrating an example of a functional configuration of the token providing server 1 to which the first exemplary embodiment is applied.

As illustrated in the figure, the token providing server 1 to which the first exemplary embodiment is applied includes a login management unit 101, an authentication management unit 102, a request reception unit 103, an expiration period determination unit 104, a token acquisition unit 105, a service information management unit 106, a notification creation unit 107, and a communication controller 108.

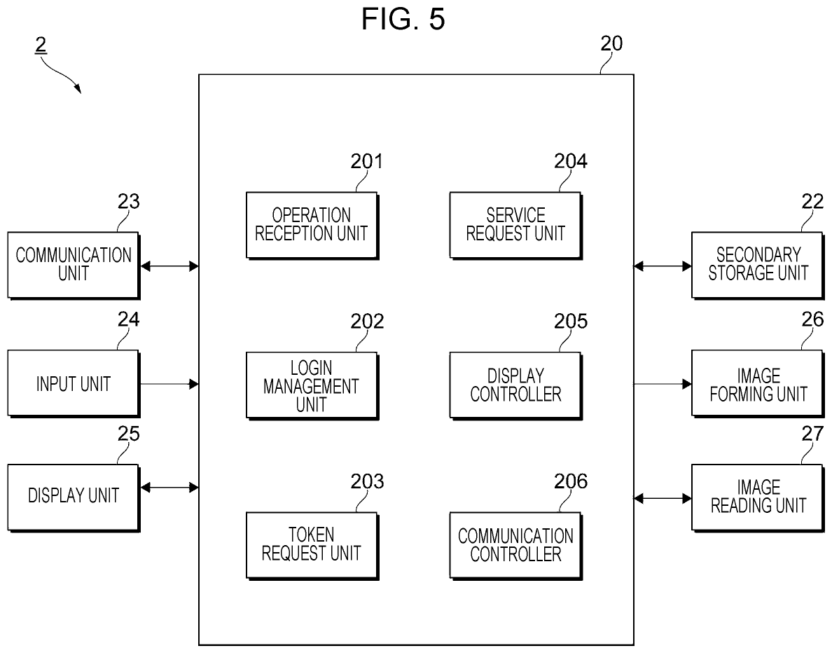

The login management unit 101 manages a login situation to the system itself from the external device 2. More specifically, a login from the external device 2 is received based on login information received from the external device 2. Login information includes, for example, an identification (ID) and a password registered in advance. A login from the external device 2 to the token providing server 1 may be hereinafter sometimes referred to as a “system login”, and distinguished from a login from the user to the external device 2 (described later with reference to FIG. 5).

Furthermore, the login management unit 101 stores, in a database stored on the secondary storage unit 12, and manages, for each user, various types of data related to system logins, such as login information that has been registered and a history of system logins.

The authentication management unit 102 manages an authentication setting between the system itself and the authorization server 3. The authentication management unit 102 associates an authentication setting performed in a state where a login from the external device 2 is performed with its login information. Then, in this associated state, information of the authentication setting is stored and managed in the database stored on the secondary storage unit 12.

Furthermore, when the login management unit 101 receives a login from the external device 2, the authentication management unit 102 extracts, from the database, and makes available, for subsequent processing in the system itself, an authentication setting associated with a corresponding piece of login information.

Note herein that, in the first exemplary embodiment, a first authentication setting including a setting of a first expiration period and a second authentication setting including a setting of a second expiration period shorter than the first expiration period are associated with each other for one piece of login information. Then, the authentication management unit 102 makes available both the first authentication setting and the second authentication setting when a login based on the one piece of login information is received.

Thus, the token providing server 1 to which the first exemplary embodiment is applied is able to use the first authentication setting, perform a request for an access token to the authorization server 3, and acquire a first access token to which the first expiration period is set. Furthermore, using the second authentication setting to perform a request for an access token to the authorization server 3 makes it possible to acquire a second access token to which the second expiration period is set.

The request reception unit 103 receives a request for an access token from the external device 2. More specifically, the request reception unit 103 receives a request for an access token from the external device 2 that is in a login state. Then, in response to the received request, various types of processing are controlled and performed, such as determination of an expiration period, acquisition of an access token, and creation of a response, which will be described later. Note that a request for an access token includes designation of a service to be utilized.

In addition, the request reception unit 103 stores and manages a history of received requests for access tokens from the external device 2 in a database stored on the secondary storage unit 12.

The expiration period determination unit 104 determines an expiration period for an access token to be acquired, based on a request that the request reception unit 103 receives. More specifically, the expiration period determination unit 104 according to the first exemplary embodiment determines to use which of the authentication settings that are the first authentication setting including the setting of the first expiration period and the second authentication setting including the setting of the second expiration period shorter than the first expiration period to perform a request for an access token to the authorization server 3 in accordance with one of the services, which is designated in the request.

Note herein that the administrator sets in advance a criterion for allowing the expiration period determination unit 104 to determine an expiration period, for example. More specifically, it is set in advance that an access token with any expiration period is to be acquired for each of the services that the service servers 4 provide, for example. In the first exemplary embodiment, the administrator has set in advance to acquire an access token with the second expiration period when the mail transmission service that the SMTP server 4b provides is designated, and to acquire an access token with the first expiration period when another service such as the file storage service that the file server 4a provides is designated.

Furthermore, the administrator sets in advance the first expiration period and the second expiration period, for example. As the second expiration period, an approximate period of time ranging from several seconds to several tens of seconds is set as a minimum period of time necessary for utilizing the mail transmission service that the SMTP server 4b provides, for example. Furthermore, as the first expiration period, an approximate period of time of several tens of minutes is set as a period of time, which is longer than the second expiration period and which provides a margin for utilization of another service such as the file storage service that the file server 4a provides, for example.

The token acquisition unit 105 creates, as a request to the authorization server 3, a request for an access token with an expiration period that the expiration period determination unit 104 determines. The token acquisition unit 105 according to the first exemplary embodiment uses an authentication setting corresponding to an expiration period that the expiration period determination unit 104 determines to perform a request for an access token to the authorization server 3. Thus, an access token with an expiration period that the expiration period determination unit 104 has determined is acquired. Then, the token acquisition unit 105 creates a response including the acquired access token as a response to the request for an access token from the external device 2. Note that, in the present exemplary embodiment, a response that the token acquisition unit 105 creates includes service information (described later).

In addition, the token acquisition unit 105 manages access tokens and update tokens, such as storage of access tokens and update tokens acquired from the authorization server 3 in the database stored on the secondary storage unit 12 and deletion of access tokens and update tokens in which their expiration periods are passed.

The service information management unit 106 manages service information necessary when the external device 2 utilizes the services that the service servers 4 provide. For example, when the request reception unit 103 has received a request for an access token, the service information management unit 106 retrieves, from the database stored on the secondary storage unit 12, and makes available service information pertaining to a designated service.

Service information is, for example, information such as a path and a port number to a storage location, which is necessary when the external device 2 utilizes the file storage service that the file server 4a provides. Furthermore, it includes information such as a mail address, a port number, and an encryption method, which are necessary when the external device 2 utilizes the mail transmission service that the SMTP server 4b provides, for example.

The notification creation unit 107 creates various types of notifications to be transmitted to other devices. When it is failed to acquire an access token from the authorization server 3 due to some reasons or when it is not possible to transmit an acquired access token to the external device 2, for example, the notification creation unit 107 creates and transmits, to a destination such as the external device 2 or a terminal that the administrator uses, an error notification indicating that effect, for example. Furthermore, when a certain operation or work by the user or the administrator of the external device 2 is necessary, a notification that the operation or work is necessary is created, for example.

The communication controller 108 controls data communications that the communication unit 13 performs (see FIG. 2). For example, the communication controller 108 performs control to cause a response including an access token that the token acquisition unit 105 acquires to be transmitted to the external device 2 representing the source of the request. In addition, control is performed to cause various types of notifications that the notification creation unit 107 creates and various types of requests for data utilized for processing in the system itself to be transmitted to other devices including the external device 2, for example.

Furthermore, the communication controller 108 extracts necessary information from data received from other devices and makes the information available in each functional unit. As a specific example, the communication controller 108 extracts information related to a request for an access token from data received from the external device 2, and makes the information available in the request reception unit 103.

### Functional Configuration of External Device 2

FIG. 5 is a block diagram illustrating an example of a functional configuration of the external device 2.

As illustrated in the figure, the external device 2 includes an operation reception unit 201, a login management unit 202, a token request unit 203, a service request unit 204, a display controller 205, and a communication controller 206.

The operation reception unit 201 receives various types of operations that the user inputs via the input unit 24. For example, the operation reception unit 201 receives an operation for requesting utilization of the scan storage function or the scan mail function, which is performed via the input unit 24. Furthermore, the operation reception unit 201 receives an operation of inputting user information utilized for a login described below, for example.

The login management unit 202 manages a login situation to the device itself from the user. More specifically, a login from the user is received based on user information that the user inputs. User information includes, for example, a user ID and a password registered in advance. Note that a login from the user to the external device 2 may be hereinafter sometimes referred to as a “user login”, and distinguished from a system login (described above with reference to FIG. 4).

In addition, the login management unit 202 stores and manages, for each user, various types of data related to user logins, such as user information that has been registered and a history of user logins, in the database stored on the secondary storage unit 22.

The token request unit 203 creates, as a request to the token providing server 1, a request for an access token, which includes information designating a service to be utilized. More specifically, when the operation reception unit 201 receives selection of a function by the user, a request for an access token, which includes information designating a service that is necessary for executing the function, is created, for example. In addition, a request for an access token may include a request for service information corresponding to a designated service.

Furthermore, the token request unit 203 stores and manages, in the database stored on the secondary storage unit 22, login information necessary for a system login to the authorization server 3 representing the destination of the request. Then, in creating a request for an access token, login information necessary for a system login to the authorization server 3 is retrieved from the database and is associated with the request for an access token.

The service request unit 204 creates a utilization request for the services to the service servers 4. A utilization request for a service includes, for example, data utilized in the services that the service servers 4 provide, such as image data created through scanning in the external device 2 and utilized in the file storage service and the mail transmission service. Furthermore, service information received from the token providing server 1, information for identifying the external device 2 (the device itself) representing the source of the request, and information for designating the service servers 4 that are the destinations of the request are included, for example.

Furthermore, the service request unit 204 associates the created utilization request for a service with the corresponding access token that the token providing server 1 has provided.

The display controller 205 controls types and content of images, various types of icons, and various types of text to be displayed on the display unit 25, and further controls display aspects such as positions and sizes of the images to be displayed, for example.

The display controller 205 performs, for example, control to display a screen that urges the user to select a function available on the external device 2. Furthermore, control to display a notification screen presenting content of a notification received from the token providing server 1 to the user is performed, for example.

The communication controller 206 controls data communications that the communication unit 23 performs. For example, the communication controller 206 performs control to transmit a request for an access token, which the token request unit 203 creates, to the token providing server 1. Furthermore, a utilization request for a service, which the service request unit 204 creates, and an access token associated with the utilization request are transmitted to the service servers 4, for example.

### Utilization of Services

Next, an outline of a flow of utilization of the services in the service utilization system 1000 will now be described herein with reference to FIGS. 1 to 6.

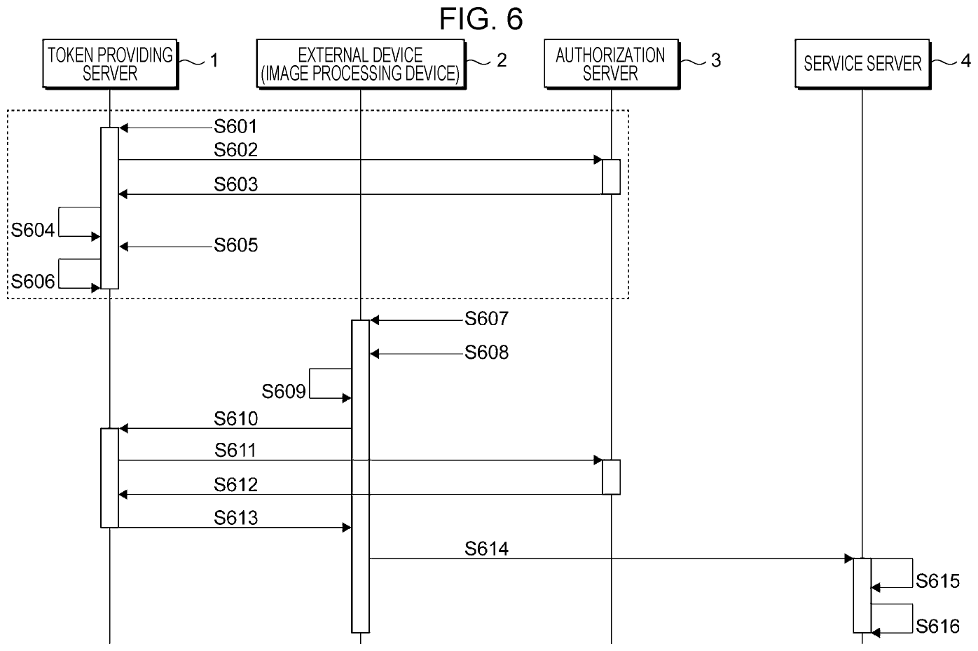

FIG. 6 is a sequence diagram illustrating an example of operation of the service utilization system 1000.

As illustrated in FIG. 6, the token providing server 1 first receives a request for adding an authentication setting from the administrator, for example (S601). Then, the token providing server 1 transmits an authorization request to the authorization server 3 (S602). At this time, the administrator inputs information necessary for an authentication setting, such as an ID and a password, and the information is transmitted to the authorization server 3, for example. The authorization server 3 authorizes the token providing server 1 in response to the authorization request, and transmits information of the authentication setting to the token providing server 1 (S603). Furthermore, the token providing server 1 stores the information of the authentication setting (S604).

Next, the administrator causes registration of service information to be performed to the token providing server 1, for example (S605). Furthermore, the token providing server 1 stores the registered service information (S606).

Note that the steps of S601 to S604 are steps related to an authentication setting between the token providing server 1 and the authorization server 3. In the present exemplary embodiment, when an authentication setting between the token providing server 1 and the authorization server 3 is performed once, information of the authentication setting is stored in the token providing server 1. Since the stored information of the authentication setting is used afterwards, it is not necessary to further perform an authentication setting.

Furthermore, the steps of S605 and S606 are steps related to registration of service information in the token providing server 1. Since registered service information is stored in the token providing server 1, it is not necessary to further register service information.

That is, the steps of S601 to S606 surrounded by a broken line in FIG. 6 may not be performed each time a service is utilized in the service utilization system 1000, but may be performed only once when an initial setting of the external device 2 is performed, for example. At and after the initial setting, it is sufficient that a service may be utilized through the steps of S607 to S616.

Now returning to FIG. 6, the external device 2 receives a login request from the user (S607).

Next, the external device 2 receives selection of a function, which the user has performed (S608). More specifically, an operation for requesting utilization of the scan storage function or the scan mail function is received, for example.

The external device 2 scans a document that the user has set, and creates image data to be used in the scan storage function or the scan mail function (S609).

The external device 2 designates a service corresponding to the selected function and performs a request for an access token to the token providing server 1 (S610). Note that this request includes a request for service information pertaining to the designated service.

In response to the request from the external device 2, the token providing server 1 performs a request for a first access token or a second access token to the authorization server 3 (S611). Note that information of an authentication setting acquired from S601 to S604 is used for this request for an access token.

The authorization server 3 issues an access token in response to the request from the token providing server 1 (S612).

The token providing server 1 returns, to the external device 2, a response including the access token and the service information acquired from the authorization server 3 (S613). Thus, the access token is provided from the token providing server 1 to the external device 2.

The external device 2 uses the access token provided from the token providing server 1 and the service information to perform a utilization request for a service to the service servers 4 (S614). Note that a utilization request includes image data to be used in the service.

The service servers 4 verify the access token included in the utilization request from the external device 2 (S615). Then, when the access token is valid, the service information and the image data included in the utilization request are used to execute the services (S616).

### Operation of Token Providing Server 1

Note herein that the operation related to provision of an access token by the token providing server 1 to which the first exemplary embodiment is applied will now be described herein in more detail. Note that the operation described below corresponds to the operation of the token providing server 1 in the steps of S610 to S612 illustrated in FIG. 6.

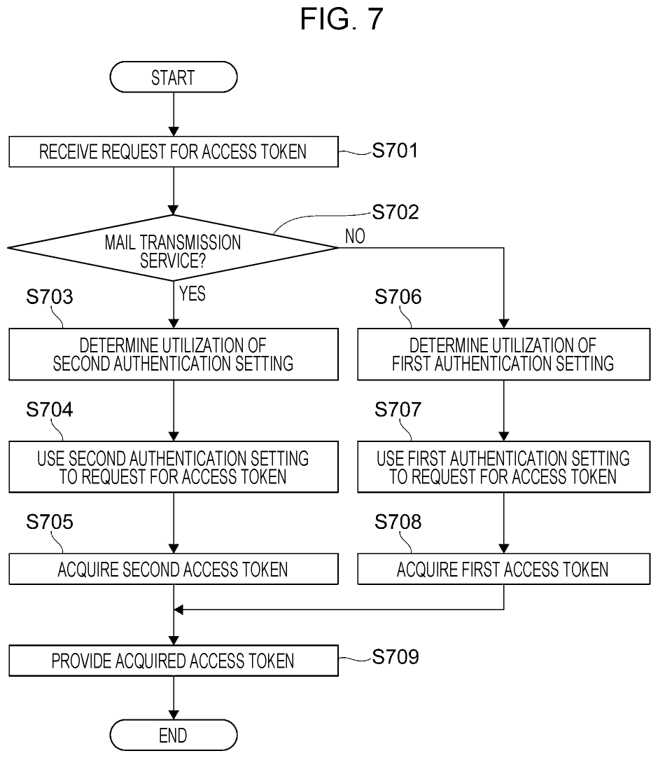

FIG. 7 is a flowchart illustrating an example of the operation related to provision of an access token in the token providing server 1 to which the first exemplary embodiment is applied.

The token providing server 1 first receives a request for an access token from the external device 2 (S701).

Next, it is determined whether or not a service designated in the request for an access token from the external device 2 is the mail transmission service (S702). Then, when the designated service is the mail transmission service (YES in S702), the token providing server 1 determines that the second authentication setting including the setting of the second expiration period is used to acquire an access token (S703).

Then, the token providing server 1 uses the second authentication setting to perform a request for an access token to the authorization server 3 (S704), and acquires a second access token in which the second expiration period is set (S705).

When the service designated in the request for an access token from the external device 2 is not the mail transmission service (NO in S702), but the file storage service, for example, on the other hand, the token providing server 1 determines that first authentication setting including the setting of the first expiration period is used to acquire an access token (S706).

Then, the token providing server 1 uses the first authentication setting to perform a request for an access token to the authorization server 3 (S707), and acquires a first access token in which the first expiration period is set (S708).

Finally, the token providing server 1 provides the access token acquired in S705 or S708 to the external device 2 representing the source of the request (S709).

Through the steps of S701 to S709, processing of receiving a request for an access token, determining an expiration period, and acquiring and providing an access token is completed in the token providing server 1, as described above.

When a request for an access token, which designates the file storage service, is received, the token providing server 1 to which the first exemplary embodiment is applied utilizes the first authentication setting, and acquires, from the authorization server 3, and provides, to the external device 2, a first access token in which the first expiration period is set, as described above. Furthermore, when a request for an access token, which designates the mail transmission service, is received, the second authentication setting is utilized to acquire, from the authorization server 3, and provide, to the external device 2, a second access token in which the second expiration period shorter than the first expiration period is set.

Note that, although, in the above description, the token providing server 1 is able to utilize the first authentication setting and the second authentication setting, and provide the first access token in which the first expiration period is set or the second access token in which the second expiration period is set in accordance with a designated service, the token providing server 1 may use three or more authentication settings including settings of expiration periods that differ from the first expiration period and the second expiration period. That is, an access token in which an expiration period different from the first expiration period and the second expiration period is set may be acquired and provided to the external device 2 in accordance with a designated service.

### Second Exemplary Embodiment

In the first exemplary embodiment described above, the token providing server 1 has selectively used a plurality of authentication settings including settings of different expiration periods to acquire access tokens having different expiration periods. In the second exemplary embodiment, on the other hand, a token providing server designates an expiration period in response to a request for an access token, and causes an authorization server to issue an access token in which the designated expiration period is set to acquire the access token with a different expiration period.

The second exemplary embodiment will now be described herein in detail with reference to FIGS. 1 to 3, 5, and 6 and FIGS. 8 and 9. Note that the first exemplary embodiment and the second exemplary embodiment are different from each other in part of the functional configuration, in part of the operation of each of the token providing servers, and in the operation of each of the authorization servers, but are identical or similar to each other in the other parts. Therefore, in the second exemplary embodiment, like reference numerals designate identical or similar components in the first exemplary embodiment, and their descriptions are omitted. Furthermore, parts that are different from those in the first exemplary embodiment are added with “′” in reference numerals and are distinguished.

### Functional Configuration of Token Providing Server 1

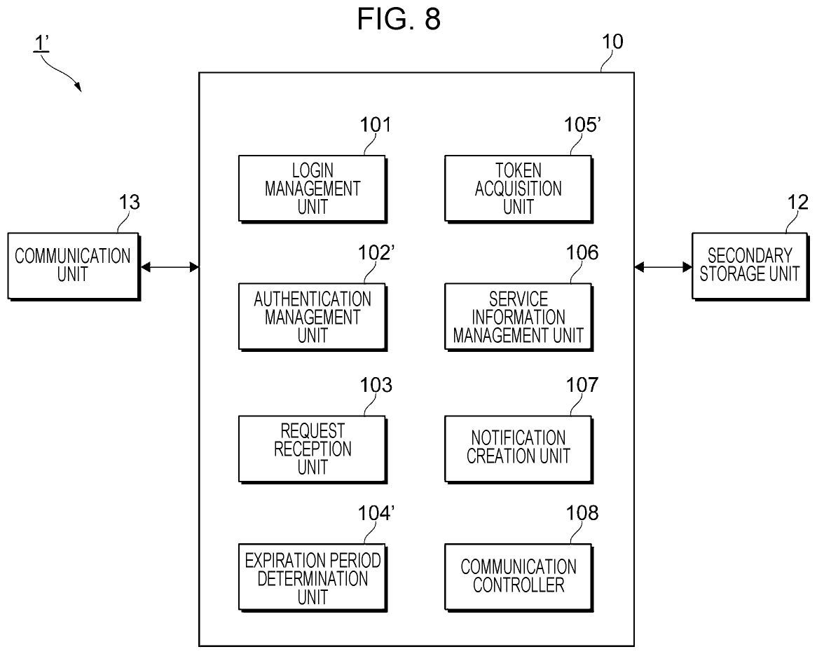

FIG. 8 is a block diagram illustrating an example of a functional configuration of a token providing server 1′ to which the second exemplary embodiment is applied.

As illustrated in the figure, the token providing server 1′ to which the second exemplary embodiment is applied includes the login management unit 101, an authentication management unit 102′, the request reception unit 103, an expiration period determination unit 104′, a token acquisition unit 105′, the service information management unit 106, the notification creation unit 107, and the communication controller 108.

The authentication management unit 102′ manages an authentication setting between the system itself and the authorization server 3. The authentication management unit 102′ associates an authentication setting performed in a state where a login from the external device 2 has been performed with its login information. Then, in this associated state, information of the authentication setting is stored and managed in the database stored on the secondary storage unit 12.

Furthermore, when the login management unit 101 receives a login from the external device 2, the authentication management unit 102′ extracts an authentication setting associated with a corresponding piece of login information from the database, and makes the authentication setting available for subsequent processing in the system itself.

Note herein that, in the second exemplary embodiment, one authentication setting is associated with one piece of login information. Then, the token providing server 1′ to which the second exemplary embodiment is applied uses a common authentication setting in both cases where an access token to which the first expiration period is set is acquired and an access token to which the second expiration period is set is acquired.

The expiration period determination unit 104′ determines an expiration period for an access token to be acquired, based on the request that the request reception unit 103 has received. More specifically, the expiration period determination unit 104′ according to the second exemplary embodiment determines whether or not to perform a request for an access token to an authorization server 3′ by designating one of the expiration periods, that is, the first expiration period and the second expiration period shorter than the first expiration period, in accordance with a service designated in the request.

Note herein that, similar to the first exemplary embodiment, the administrator sets in advance a criterion, under which the expiration period determination unit 104′ determines an expiration period, and lengths of the first expiration period and the second expiration period, for example.

The token acquisition unit 105′ creates, as a request to the authorization server 3′, a request for an access token with an expiration period that the expiration period determination unit 104′ determines. In the token acquisition unit 105′ according to the second exemplary embodiment, a request for an access token to the authorization server 3′ includes information designating an expiration period that the expiration period determination unit 104′ determines. With this information, it is possible to issue an access token to which an expiration period that the authorization server 3′ designates is set, and acquire the access token to which the designated expiration period is set. Then, the token acquisition unit 105′ creates a response including the acquired access token as a response to the request for an access token from the external device 2.

In addition, the token acquisition unit 105′ manages access tokens and update tokens, such as storage of access tokens and update tokens acquired from the authorization server 3′ in the database stored on the secondary storage unit 12 and deletion of access tokens and update tokens in which their expiration periods are passed.

The authorization server 3′ according to the second exemplary embodiment issues, based on information designating an expiration period included in a request for an access token, an access token in which the designated expiration period is set. More specifically, when a request for an access token includes information designating the first expiration period, a first access token in which the first expiration period is set is issued. Furthermore, when a request for an access token includes information designating the second expiration period, a second access token in which the second expiration period is set is issued.

### Utilization of Services

A flow of utilization of a service in the second exemplary embodiment is identical or similar to the flow of utilization of a service in the first exemplary embodiment described with reference to FIG. 6, and its description is omitted in here. Note that, in the second exemplary embodiment, the operation of the token providing server 1, which is illustrated in FIG. 6, is replaced with operation of the token providing server 1′, and the operation of the authorization server 3 is replaced with operation of the authorization server 3′.

### Operation Example of Token Providing Server 1′

Operation related to provision of an access token by the token providing server 1′ to which the second exemplary embodiment is applied will now be described herein in detail. Note that the operation described below corresponds to the operation of the token providing server 1′, in the steps of S609 to S611 illustrated in FIG. 6.

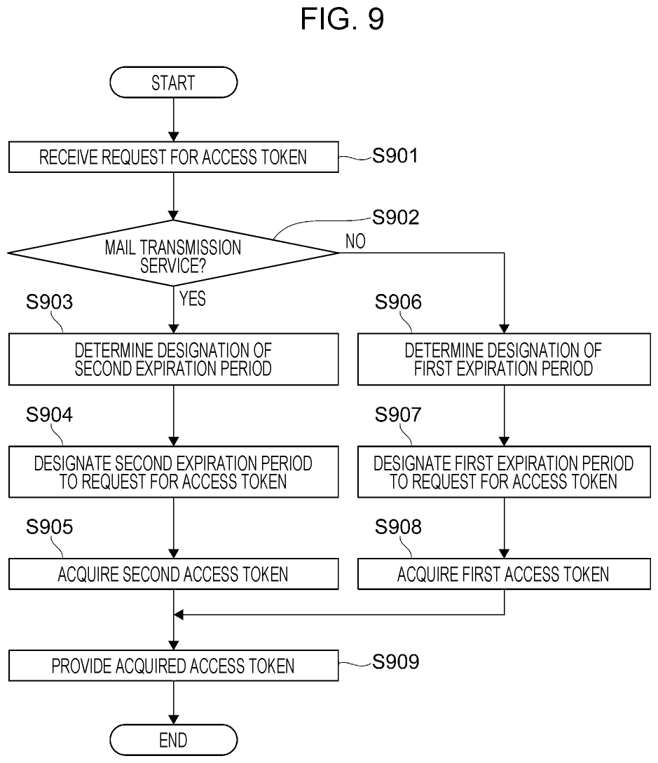

FIG. 9 is a flowchart illustrating an example of the operation related to provision of an access token in the token providing server 1′ to which the second exemplary embodiment is applied.

The token providing server 1′ first receives a request for an access token from the external device 2 (S901).

Next, it is determined whether or not a service designated in the request for an access token from the external device 2 is the mail transmission service (S902). Then, when the designated service is the mail transmission service (YES in S902), the token providing server 1′ determines that the second expiration period is designated to acquire an access token (S903).

Then, the token providing server 1′ designates the second expiration period to perform a request for an access token to the authorization server 3′ (S904), and acquires a second access token in which the second expiration period is set (S905).

When the service designated in the request for an access token from the external device 2 is not the mail transmission service (NO in S902), but the file storage service, for example, on the other hand, the token providing server 1′ determines that the first expiration period is designated to acquire an access token (S906).

Then, the token providing server 1′ designates the first expiration period to perform a request for an access token to the authorization server 3′ (S907), and acquires a first access token in which the first expiration period is set (S908).

Finally, the token providing server 1′ provides the access token acquired in S905 or S908 to the external device 2 representing the source of the request (S909).

Through the steps of S901 to S909, processing of receiving a request for an access token, determining an expiration period, and acquiring and providing an access token is completed in the token providing server 1′, as described above.

When a request for an access token, which designates the file storage service, is received, the token providing server 1′ to which the second exemplary embodiment is applied designates the first expiration period, performs a request for an access token to the authorization server 3′, acquires a first access token, and provides the acquired first access token to the external device 2, as described above. Furthermore, when a request for an access token, which designates the mail transmission service, is received, the second expiration period is designated, a request for an access token is performed to the authorization server 3′, a second access token is acquired, and the acquired second access token is provided to the external device 2.

Note herein that, in the second exemplary embodiment, the second expiration period may be designated based on information of a utilization period when a service was utilized previously, for example. The token providing server 1′ may set and designate the second expiration period based on information of a utilization period when the mail transmission service was used previously, for example. Information of this utilization period is extracted from a history (a log) of various types of processing in the token providing server 1′ or the external device 2, for example. When the mail transmission service is utilized, a utilization period may be calculated from a period of time from when an access token is acquired from the authorization server 3′ to when a notification of completion of utilization of the service is received from the external device 2, in the token providing server 1′, for example. Furthermore, it may be calculated from a period of time from when an access token is acquired to when utilization of the service is completed, in the external device 2, for example. A value of a utilization period to be used may be a value corresponding to that of one time of previous utilization, or may be an average value or a maximum value of those of a plurality of times of utilization.

Furthermore, if the service servers 4 provide services utilizing data acquired from the external device 2, such as the mail transmission service, it may take time for performing processing in each device or communications between devices, depending on a volume of data. Therefore, in the second exemplary embodiment, the second expiration period may be designated based on information related to a volume of data to be utilized. For example, the token providing server 1′ may extend the second expiration period longer as a volume of image data to be transmitted in the mail transmission service increases, and may shorten the second expiration period as the volume decreases. Note that, in this case, it is sufficient that information related to a volume of data may be included in a request for an access token from the external device 2.

It is understood that both the token providing servers 1 and 1′ to which the first and second exemplary embodiments described above are applied, respectively, are examples of an information processing system that, when a request for an access token, which designates the file storage service, is received from the external device 2, acquires a first access token in which the first expiration period is set from the authorization servers 3 and 3′ and provides the acquired first access token to the external device 2, and that, when a request for an access token, which designates the mail transmission service, is received, acquires a second access token in which the second expiration period shorter than the first expiration period is set from the authorization servers 3 and 3′ and provides the acquired second access token to the external device 2.

### Modification Examples and Others

Although the embodiments of the present disclosure have been described above, the technical scope of the present disclosure is not limited to the scope described as the first and second exemplary embodiments. Those that are variously modified or improved without departing from the technical idea of the present disclosure are also included in the present disclosure.

Although, in the first and second exemplary embodiments, the file storage service has been exemplified as the first service, and the mail transmission service has been exemplified as the second service, for example, there are no limitations in types of services. Furthermore, although it has been described an example in which the external device 2 is an image processing device, and image data created through scanning in the external device 2 is utilized in the services, there are no limitations in data to be utilized in the services, and various types of data that the external device 2 holds may be used.

Furthermore, although, in the first and second exemplary embodiments, service information has been managed by the token providing servers 1 and 1′ and provided to the external device 2, for example, such a configuration is not essential. Service information necessary in the external device 2 may be stored.

By the way, the second expiration period may be set to an extremely short period of time, such as a minimum period of time necessary for utilizing a service. Therefore, when it takes a longer period of time than a period of time that is taken normally for performing processing in each device or communications between devices in the service utilization system 1000, an expiration period of an access token may be passed before utilization of one of the services is completed. Therefore, in the first and second exemplary embodiments, the token providing servers 1 and 1′ may acquire, when information (which may be hereinafter sometimes referred to as “expiration information”) indicating that it is not possible to access a service due to that the second expiration period has passed is received from the external device 2, a third access token in which a third expiration period longer than the second expiration period is set from the authorization servers 3 and 3′ and provide the acquired third access token to the external device 2. The third expiration period may be a period of time that the administrator sets in advance, for example. Furthermore, in the first exemplary embodiment, a plurality of third expiration periods may be set and a plurality of corresponding authentication settings may be prepared, and the third access tokens may be provided in an order of shorter expiration periods, until no expiration information is received from the external device 2, for example. Furthermore, in the second exemplary embodiment, the third expiration period may be repeatedly extended and the third access token with the repeatedly extended third expiration period may be provided, until no expiration information is received from the external device 2, for example.

Note that it is sufficient that the third expiration period is longer than the second expiration period, and the third expiration period may be a period of time equal to or longer than the first expiration period, for example. However, setting the third expiration period to a period of time shorter than the first expiration period is preferable in terms of suppressing unauthorized utilization of an access token, compared with a case where the third expiration period is set to a period of time equal to or longer than the first expiration period.

### Appendix

(((1)))

An information processing system comprising one or more processors, and, in response to a request from an external device, acquiring, from an authorization server, and providing, to the external device, an access token that enables access to a designated service,

wherein the one or more processors are configured to:

acquire, from the authorization server, and provide, to the external device, a first access token in which a first expiration period is set, when the request designating a first service is received; and

acquire, from the authorization server, and provide, to the external device, a second access token in which a second expiration period shorter than the first expiration period is set, when the request designating a second service is received.
(((2)))

The information processing system according to (((1))), wherein the one or more processors are configured to:

utilize a first authentication setting including a setting of the first expiration period that the system has performed to the authorization server to acquire the first access token; and

utilize a second authentication setting including a setting of the second expiration period that the system has performed to the authorization server to acquire the second access token.
(((3)))

The information processing system according to (((2))), wherein the one or more processors are configured to:

associate a login performed from the external device to the system with the first authentication setting and the second authentication setting; and

make available the first authentication setting and the second authentication setting in response to the login.
(((4)))

The information processing system according to (((1))), wherein the second expiration period is designated from the system to the authorization server.
(((5)))

The information processing system according to (((4))), wherein the designation is performed based on information of a utilization period when the second service was utilized previously.
(((6)))

The information processing system according to (((4))), wherein

the second service is a service that utilizes data acquired from the external device, and

the designation is performed based on information related to a volume of the data.
(((7)))

The information processing system according to any one of (((1))) to (((6))), wherein the one or more processors are configured to:

provide the second access token in response to the request from the external device; and

when information indicating that the second service is unable to be accessed due to that the second expiration period has passed is received from the external device, acquire, from the authorization server, and provide, to the external device, a third access token in which a third expiration period longer than the second expiration period is set.
(((8)))

The information processing system according to (((7))), wherein the third expiration period is shorter than the first expiration period.
(((9)))

The information processing system according to claims (((1))) to (((8))), wherein the second service is a service that uses an electronic mail to transmit data that the external device holds.
(((10)))

A program causing a computer to, in response to a request from an external device, acquire, from an authorization server, and provide, to the external device, an access token enabling access to a designated service to execute a process comprising:

acquiring, from the authorization server, and providing, to the external device, a first access token in which a first expiration period is set, when the request designating a first service is received; and

acquiring, from the authorization server, and providing, to the external device, a second access token in which a second expiration period shorter than the first expiration period is set, when the request designating a second service is received.

What is claimed is:

1. An information processing system comprising one or more processors, and, in response to a request from an external device, acquiring, from an authorization server, and providing, to the external device, an access token that enables access to a designated service,
wherein the one or more processors are configured to:
acquire, from the authorization server, and provide, to the external device, a first access token in which a first expiration period is set, when the request designating a first service is received; and
acquire, from the authorization server, and provide, to the external device, a second access token in which a second expiration period shorter than the first expiration period is set, when the request designating a second service is received.

2. The information processing system according to claim 1, wherein the one or more processors are configured to:
utilize a first authentication setting including a setting of the first expiration period that the system has performed to the authorization server to acquire the first access token; and
utilize a second authentication setting including a setting of the second expiration period that the system has performed to the authorization server to acquire the second access token.

3. The information processing system according to claim 2, wherein the one or more processors are configured to:
associate a login performed from the external device to the system with the first authentication setting and the second authentication setting; and
make available the first authentication setting and the second authentication setting in response to the login.

4. The information processing system according to claim 1, wherein the second expiration period is designated from the system to the authorization server.

5. The information processing system according to claim 4, wherein the designation is performed based on information of a utilization period when the second service was utilized previously.

6. The information processing system according to claim 4, wherein
the second service is a service that utilizes data acquired from the external device, and
the designation is performed based on information related to a volume of the data.

7. The information processing system according to claim 1, wherein the one or more processors are configured to:
provide the second access token in response to the request from the external device; and
when information indicating that the second service is unable to be accessed due to that the second expiration period has passed is received from the external device, acquire, from the authorization server, and provide, to the external device, a third access token in which a third expiration period longer than the second expiration period is set.

8. The information processing system according to claim 2, wherein the one or more processors are configured to:
provide the second access token in response to the request from the external device; and
when information indicating that the second service is unable to be accessed due to that the second expiration period has passed is received from the external device, acquire, from the authorization server, and provide, to the external device, a third access token in which a third expiration period longer than the second expiration period is set.

9. The information processing system according to claim 3, wherein the one or more processors are configured to:
provide the second access token in response to the request from the external device; and
when information indicating that the second service is unable to be accessed due to that the second expiration period has passed is received from the external device, acquire, from the authorization server, and provide, to the external device, a third access token in which a third expiration period longer than the second expiration period is set.

10. The information processing system according to claim 4, wherein the one or more processors are configured to:
provide the second access token in response to the request from the external device; and
when information indicating that the second service is unable to be accessed due to that the second expiration period has passed is received from the external device, acquire, from the authorization server, and provide, to the external device, a third access token in which a third expiration period longer than the second expiration period is set.

11. The information processing system according to claim 5, wherein the one or more processors are configured to:
provide the second access token in response to the request from the external device; and
when information indicating that the second service is unable to be accessed due to that the second expiration period has passed is received from the external device, acquire, from the authorization server, and provide, to the external device, a third access token in which a third expiration period longer than the second expiration period is set.

12. The information processing system according to claim 6, wherein the one or more processors are configured to:
provide the second access token in response to the request from the external device; and
when information indicating that the second service is unable to be accessed due to that the second expiration period has passed is received from the external device, acquire, from the authorization server, and provide, to the external device, a third access token in which a third expiration period longer than the second expiration period is set.

13. The information processing system according to claim 7, wherein the third expiration period is shorter than the first expiration period.

14. The information processing system according to claim 8, wherein the third expiration period is shorter than the first expiration period.

15. The information processing system according to claim 9, wherein the third expiration period is shorter than the first expiration period.

16. The information processing system according to claim 10, wherein the third expiration period is shorter than the first expiration period.

17. The information processing system according to claim 11, wherein the third expiration period is shorter than the first expiration period.

18. The information processing system according to claim 12, wherein the third expiration period is shorter than the first expiration period.

19. The information processing system according to claim 1, wherein the second service is a service that uses an electronic mail to transmit data that the external device holds.

20. A non-transitory computer readable medium storing a program causing a computer to, in response to a request from an external device, acquire, from an authorization server, and provide, to the external device, an access token enabling access to a designated service to execute a process comprising:
acquiring, from the authorization server, and providing, to the external device, a first access token in which a first expiration period is set, when the request designating a first service is received; and
acquiring, from the authorization server, and providing, to the external device, a second access token in which a second expiration period shorter than the first expiration period is set, when the request designating a second service is received.
